(19) United States
(12) Patent Application Publication
(10) Pub. No.: US 2011/0024459 A1
(43) Pub. Date: Feb. 3, 2011

(54) Aerosol Spray Can Agitator

(76) Inventors: Thomas M. Smrt, Cary, IL (US); John F. Smrt, Cary, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/534,567

(22) Filed: Aug. 3, 2009

(51) Int. Cl. B67D 7/84; B65D 83/14; A01C 15/16

(52) U.S. Cl. 222/167; 222/174; 222/609

(57) ABSTRACT

An aerosol spray can agitator consists of a device for discharging the contents of an aerosol spray can onto a surface, wherein the device is capable of holding and agitating a spare aerosol spray can. A first aerosol spray can holder is disposed on a housing. An actuator mounted on the first aerosol spray can moves between discharging and non-discharging positions. The device further including a trigger actuator displaced from the aerosol spray can actuator capable of moving the aerosol spray can actuator between the discharging and non-discharging positions, which allows an operator to discharge the contents of the aerosol spray can onto a surface. The device also has at least one rotatable wheel disposed on the housing which rotates as the device is moved relative to the surface and a second spray can holder disposed on the wheel for holding a second aerosol spray can. The second spray can holder is adapted to hold spray cans with various types of bottom rim configurations.

### TECHNICAL FIELD

The various embodiments of the present invention are directed to movable devices for discharging the contents of aerosol spray cans onto a surface and thereby marking that surface. The devices are further capable of securing various types of different aerosol sized spray cans.

### BACKGROUND OF THE INVENTION

It is well known to use aerosol spray cans for dispensing marking compositions. For example, aerosol spray cans are often used for marking or striping parking lots, construction sites, sporting fields, and factory floors. Devices have been developed for use with aerosol spray cans which allow a person making such marks or stripes to remain relatively upright, while at the same time the spray can is positioned relatively close to the surface to be marked. These devices further allow the discharge of the marking compositions from the spray can to be controlled by the user. Examples of these types of devices are provided by U.S. Pat. Nos. 4,895,304, 5,148,988, and 5,368,202.

With each of these devices, once the aerosol spray can's supply of marking composition is exhausted, it must be removed and replaced. Before the new aerosol spray can of marking composition can be inserted into the marking device, however, it typically must be shaken vigorously in order to ensure thorough distribution of the marking composition components within the spray can. Shaking a new spray can is not only time consuming, but can be tiring. U.S. Pat. No. 5,785,214 is directed to a device for holding and agitating an aerosol spray can, but this device suffers from the deficiency that it can only accept and secure a single type and size of aerosol spray can.

Therefore, there is a continuing need for an inexpensive, secure means for aerosol spray can agitator that allows for compatibility with various different styles and sizes of aerosol spray cans.

### CONCISE DESCRIPTION OF THE DRAWINGS

FIG. 1 depicts a perspective view of an aerosol spray can discharging device.

FIG. 2 depicts a cross-sectional view illustrating engagement of one type of aerosol spray can with the spare spray can holder.

FIG. 3 depicts a side view of the aerosol spray can spare container holder.

FIG. 4 depicts a cross-sectional view illustrating engagement of another type of aerosol spray can with the spare spray can holder.

### SUMMARY OF THE INVENTION

Embodiments of the present invention meet the needs described above in an aerosol spray can agitator. Generally described, the present invention discharges the contents of an aerosol spray can onto a surface, wherein the device is capable of holding and agitating a spare aerosol spray can. The device comprises a housing; means disposed on the housing for holding a first aerosol spray can having an actuator mounted on the spray can that moves between discharging and non-discharging positions; actuating means which effects movement of the aerosol spray can actuator between the discharging and non-discharging positions; means disposed on the device for controlling the actuating means which allows an operator to discharge the contents of the aerosol spray can onto the surface; at least one rotatable wheel disposed on the housing which rotates as the device is moved relative to the surface; and means disposed on the wheel for holding a second aerosol spray can, wherein the second aerosol spray can may be of varying size, shape and construction.

### DETAILED DESCRIPTION

In accordance with one embodiment of the present invention, there is provided a device for discharging the contents of an aerosol spray can onto a surface which is capable of holding and agitating a spare spray can while the device is being operated. The aerosol spray can agitator eliminates the need for the operator to manually agitate the spare spray can prior to using it to replace the original discharging spray can. The present invention provides a relatively simple mechanism wherein the movement of the aerosol spray can discharging device over the surface agitates a spare aerosol spray can.

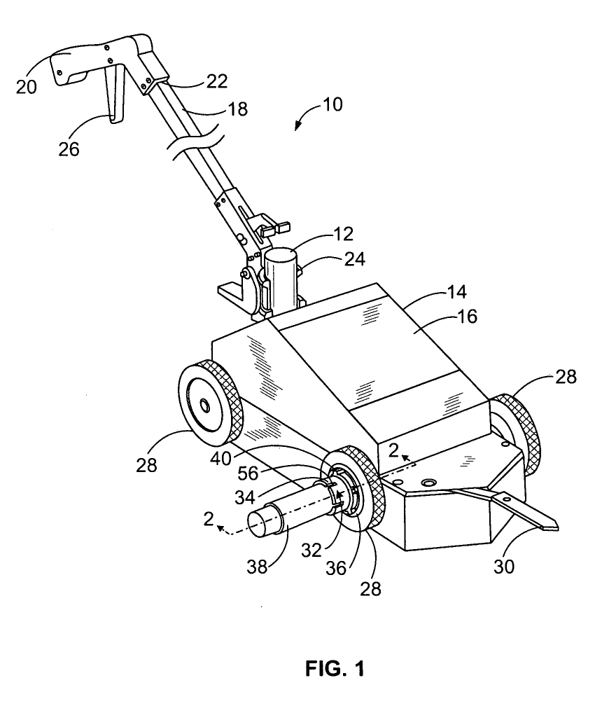

Referring now to FIG. 1, the device 10 of the present invention shown in use with a conventional aerosol spray can 12 designed to be discharged in the inverted position. The aerosol spray can 12 includes an actuator mounted thereon (not shown) that moves between discharging and non-discharging positions, thereby controlling the discharge of the contents of the aerosol spray can 12.

The device 10 includes a housing 14 on or within which the various components of the device are disposed. In the embodiment illustrated in FIG. 1, the housing 14 comprises a relatively hollow body portion 16 to which is attached a handle 18. A handle grip 20 for manual grasping by the user of the device is disposed at the top end 22 of the handle 18. Means for receiving and holding an aerosol spray can 12 is disposed on the housing 16. In the illustrated embodiment of FIG. 1, the spray can holding means comprises a generally semi-cylindrical structure 24 which is sized to receive an inverted aerosol spray can. Within the spray can holder 24 is an annular flange (not shown) adapted to engage a ridge portion on the aerosol spray can thereby properly positioning and retaining the aerosol spray can within the semi-cylindrical structure 24. As is well known, the flange should be located on the spray can holder 24 so the actuator is located at a distance from the surface so that the desired mark or stripe is provided thereon. This positioning, of course, can be varied to provide for the results desired, as will be appreciated by those skilled in the art.

The device 10 also includes an actuating means which moves the aerosol spray can actuator between discharging and non-discharging positions. In the embodiment shown in FIG. 1, the actuating means comprises an actuator rod (not shown) that is mounted on the device and is movable relative to the aerosol spray can disposed in the aerosol spray can holder 24. In this way, the actuating means can be moved between a discharging position, wherein the actuator means effects movement of the aerosol spray can actuator into the discharging position, and a non-discharging position wherein the actuator is not moved into the discharging position.

In the case of the aerosol spray cans used with the embodiments disclosed herein, when an operator desires to mark a surface, the actuating means must displace the actuator sideways, thus opening the spring-biased valve of the spray can and providing for discharge of the marking composition from the spray can. When the actuating means is retracted, the actuator will return to its former position and the spring-biased valve will re-close, halting the discharge.

The device 10 further includes means for controlling the movement of the actuating means, and thereby the aerosol spray can actuator, between the discharging and non-discharging positions. As exemplified in FIG. 1, the control means comprises a triggering mechanism which includes a spring-biased trigger 26 that is disposed adjacent the top end 21 of the handle 18 near the handle grip 20. The trigger 26 is attached to and controls the movement of an actuating means, which in the embodiment illustrated in FIG. 1 comprises a trigger rod (not shown). The embodiment illustrated in FIG. 1 also optionally includes a pointer 30 which can be used by the operator as an aid moving the device along a desired path.

As will be appreciated by one of ordinary skill, there are a number of component configurations by which the spray can actuator can be displaced, and any of those can be used in the embodiments disclosed and claimed herein.

The device further comprises at least one wheel 28 which is disposed on the device 10. As exemplified in FIG. 1, the device includes four wheels 28 which are rotatably mounted to the housing 16. While the embodiment illustrated in FIG. 1 has four wheels, those skilled in the art will appreciate that the present invention is equally applicable to any aerosol spray can discharging device which has one or more wheels which enable it move over a surface which is to be marked.

In accordance with one important aspect of the present invention, the device 10 further includes means for holding and agitating a second or spare aerosol spray can 38. In one preferred embodiment of the invention, as shown in FIGS. 1-4, the means for holding and agitating the spare spray can 38 comprises a second or spare spray can holder 32 mounted on one of the wheels 28 of the device 10. As will be well appreciated by those skilled in the art, this wheel may ride directly on the surface over which the device travels, or may be rotated directly or indirectly by a wheel that rides directly on the surface.

Thus, as the operator of the device 10 moves the device over a surface to be marked, the mere turning of the wheel will result in the agitation of a spare spray can being held in the spare spray can holder.

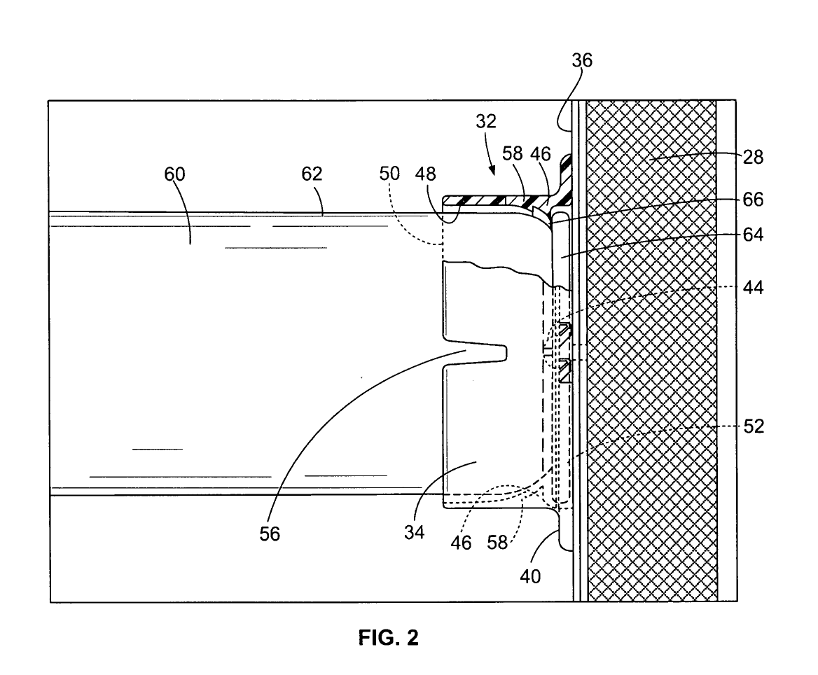

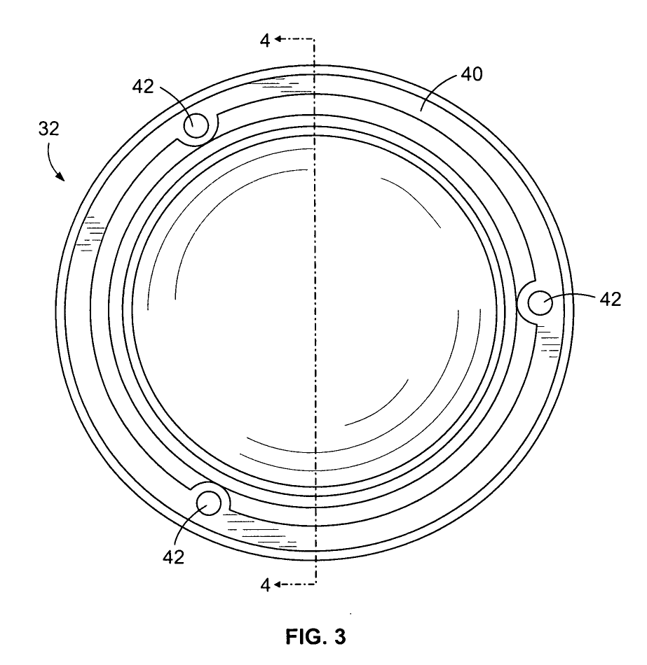

As best shown in FIGS. 2, 3 and 4, in one embodiment of invention, the spare spray can holder 32 may be configured as a generally cylindrical structure 34 which can retain and hold a spare spray can 38 such that the spray can extends generally perpendicular to the hub 36 of the wheel 28. Viewed in another perspective, the longitudinal axis of the aerosol spray can is oriented parallel to the longitudinal axis of the axle to which the wheel is rotatably mounted. As shown in FIGS. 2 and 3, the spare spray can holder 32 further includes an annular collar 40 having at least one hole 42 therein which allows the spare spray can holder 32 to be attached to the hub 36 of one of the wheels via any suitable fastening means, such as the illustrated screws 44. Those skilled in the art will appreciate that while the illustrated embodiments of the invention show the cylindrical structure mounted at the center of the wheel 28, in other embodiments the cylindrical structure could be mounted off-center, e.g., eccentrically, on the wheel.

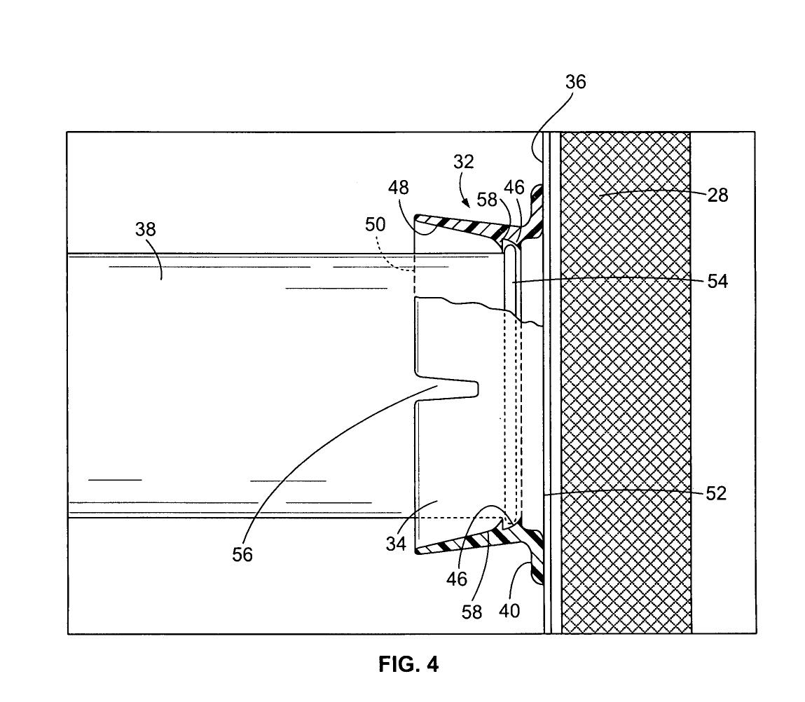

In order to ensure that the spare spray can 38 is securely held and retained, the spare spray can holder 32 is adapted such that a spare spray can is held within the cylindrical structure 34 by a relatively tight friction fit. In the embodiment illustrated in FIGS. 1-4, the cylindrical structure 34 includes a ridge portion 46 and a tapered side wall 48 which help to achieve the desired friction fit. In particular, the side wall 48 of the cylindrical structure is tapered such that the diameter of cylindrical structure decreases as the wall runs from the open end 50 toward the wheel hub end 52 of the cylindrical structure. For further securing the spare spray can in place, a plurality of retaining tabs are formed on the inner side wall of the cylindrical structure. Referring to FIG. 4, retaining tabs 58 are shown. The plurality of retaining tabs 58 are configured to engage ridge 54 that is typically formed at the base of an aerosol spray can, thereby positively locking the spray can into the spare spray can holder.

Referring now to FIG. 2, an annular ridge 46 is formed on the inner side wall of the cylindrical structure. Certain models of aerosol spray cans do not employ a ridge at the base of the spray can such as described above with respect to ridge 54 of aerosol spray can 38. The annular ridge 46 is formed on the inner side wall of the cylindrical structure adjacent the wheel hub end 52. This annular ridge 46 is configured to engage the an aerosol spray can 60 of the type that employs a side wall 62 that tapers at the base rim 64 to create a recessed groove 66, thereby positively locking the spray can into the spare spray can holder.

In addition, and in order to help the spare spray can holder accommodate spray cans of varying sizes, one preferred embodiment of the spare spray can holder 32 includes at least one slit 56 which enables the cylindrical structure 34 to expand to accommodate slightly larger spray cans. As best shown in FIGS. 1 and 3, the spare spray can holder 32 includes four such slits 56 which run axially in the circumferential surface of the cylindrical structure 34.

While the components of the foregoing devices which allow a user to control the discharge of the aerosol spray can held at a remote distance from the user have been described herein in connection with certain preferred embodiments, those skilled in the art will appreciate that the present invention is equally applicable to other aerosol spray can discharging devices.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments and equivalents falling within the scope of the appended claims.

Various features of the invention are set forth in the following claims.

What is claimed is:

1. A device for discharging the contents of a first aerosol container onto a surface and for holding and agitating a second aerosol container comprising:
a housing;
means disposed on the housing for holding a first aerosol container, wherein the container has an actuator mounted on the container that moves between discharging and non-discharging positions;
actuating means which effects movement of the aerosol container actuator between the discharging and non-discharging positions;
means disposed on the device for controlling the actuating means which allows an operator to discharge the contents of the aerosol container onto the surface;
at least one rotatable wheel disposed on the device which rotates as the device is moved relative to the surface; and
means disposed on the wheel for holding a second aerosol container;

2. The device of claim 1 wherein the wheel has a hub and the means for holding a second aerosol container comprises a generally cylindrical structure having a longitudinal axis, the cylindrical structure being mounted on the wheel such that the longitudinal axis of the cylindrical structure is perpendicular to the hub of the wheel, wherein the cylindrical structure includes an annular ridge therein, and further wherein the cylindrical structure includes a plurality of retaining tabs on the inner side wall of the cylindrical structure.

3. The device of claim 2 wherein the cylindrical structure is mounted to the center of the wheel hub.

4. The device of claim 2 wherein the cylindrical structure is mounted eccentrically on the wheel hub.

5. The device of claim 2 wherein the annular ridge is formed on the inner side wall of the cylindrical structure adjacent the wheel hub end.

6. The device of claim 2 wherein the cylindrical structure includes a tapered side wall.

7. The device of claim 2 wherein the cylindrical structure includes a side wall with at least one slit therein.

8. The device of claim 2 wherein the plurality of retaining tabs are spaced apart radially along the inner side wall of the cylindrical structure generally at the mid point of the inner side wall.

9. A device for discharging the contents of a first aerosol container onto a surface and for holding and agitating a second aerosol container comprising:
a housing;
means disposed on the housing for holding a first aerosol container, wherein the container has an actuator mounted on the container that moves between discharging and non-discharging positions;
actuating means which effects movement of the aerosol container actuator between the discharging and non-discharging positions;
means disposed on the device for controlling the actuating means which allows an operator to discharge the contents of the aerosol container onto the surface;
at least one rotatable wheel disposed on the device which rotates as the device is moved relative to the surface;
a generally cylindrical structure mounted on the wheel for holding a second aerosol container; and
a second aerosol container disposed in the generally cylindrical structure mounted on the rotatable wheel.

10. The device of claim 9 wherein the wheel has a hub and the means for holding a second aerosol container comprises a generally cylindrical structure having a longitudinal axis, the cylindrical structure being mounted on the wheel such that the longitudinal axis of the cylindrical structure is perpendicular to the hub of the wheel, wherein the cylindrical structure includes an annular ridge therein, and further wherein the cylindrical structure includes a plurality of retaining tabs on the inner side wall of the cylindrical structure.
